(19) United States
(12) Patent Application Publication
(10) Pub. No.: US 2026/0105350 A1
(43) Pub. Date: Apr. 16, 2026

(54) OPTIMIZING FEATURE SELECTION FOR REAL-TIME INFERENCE IN RESOURCE-CONSTRAINED EDGE DEVICES

(71) Applicant: Dell Products L.P., Round Rock, TX (US)

(72) Inventors: Pablo Nascimento da Silva, Niterói (BR); Paulo Abelha Ferreira, Rio de Janeiro (BR); Vinicius Michel Gottin, Rio de Janeiro (BR)

(21) Appl. No.: 18/912,361

(22) Filed: Oct. 10, 2024

(51) Int. Cl. G06N 20/00

(52) U.S. Cl. CPC G06N 20/00

(57) ABSTRACT

One example method includes receiving, by a near-edge device from each edge device in a work area of an environment, a feature subset, and a size and composition of the feature subset is not fixed, selecting, by the near-edge device, a best feature subset from the feature subsets received from the edge devices, sending, by the near-edge device to the edge devices, a size of the best feature subset, receiving, from one of the edge devices by the near-edge device, both a final feature score that is based on a data point that was consolidated at the one edge device and a top-size subset of features, and using, by the near-edge device, the top-size subset of features to generate a prediction, and transmitting the prediction to the edge device.

### TECHNOLOGICAL FIELD OF THE DISCLOSURE

Embodiments disclosed herein generally relate to the operation of autonomous devices in an edge environment. More particularly, at least some embodiments relate to systems, hardware, software, computer-readable media, and methods, for optimizing feature selection for real-time inference in resource-constrained edge devices.

### BACKGROUND

In the example context of edge environments, one current problem is that of feature selection for real-time inferencing using unreliable sensors in an edge environment. Another problem that arises is the selection of the best subset of features needed to increase the performance of the model running on resource-constrained edge devices, that is, the selection of the subset of features is not optimized to increase the performance of the model, and at the same time, reduce the consumption of resources by those resource-constrained edge devices.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an example prediction process after feature selection in an edge node.

FIG. 2 discloses an overview of an example method for collecting data from edge devices and sensors to build an initial model, according to one embodiment.

FIG. 3 discloses an example method and architecture for the collection of data from environment sensors and selected edge devices, according to one embodiment.

FIG. 4 discloses aspects of a training stage method, according to one embodiment.

FIG. 5 discloses an example method for dividing an environment into working areas, according to one embodiment.

FIG. 6 discloses an example method for selecting an optimized value of k, according to one embodiment.

FIG. 7 discloses an example method for obtaining predictions from a resourceful server, according to one embodiment.

FIG. 8 discloses an example inference process performed by an edge device, according to one embodiment.

FIG. 9 discloses an example computing entity configured and operable to perform any of the disclosed methods, processes, and operations.

### DETAILED DESCRIPTION OF SOME EXAMPLE EMBODIMENTS

Embodiments disclosed herein generally relate to the operation of autonomous devices in an edge environment. More particularly, at least some embodiments relate to systems, hardware, software, computer-readable media, and methods, for optimizing feature selection for real-time inference in resource-constrained edge devices.

One or more example embodiments comprise a method that is concerned with optimized feature selection for use in the performance of real-time inferencing by one or more edge devices. Example methods according to one or more embodiments may be performed in whole or in part by any, or any combination of, one or more edge devices, one or more near edge nodes, and a central server. The edge devices, near edge nodes, and central server may all communicate with each other to transmit data, models, and any other information disclosed herein.

A method according to one embodiment comprises three phases, and the method may comprise the following operations: performing a first phase—which may comprise a ‘training/preparation stage’—comprising collecting training data from a variety of devices, and then using the collected data for training lazy classifiers which are stored in a near edge server; performing a second phase—which may comprise a ‘feature subset tuning stage—comprising a process of deciding which feature are relevant for each type of location inside the environment—this process may be dynamically run to decide the number of features that should be used in each location of the environment, so that the predictive accuracy is maximized, and costs associated with data transmission reduced; and, performing a third phase—which may comprise an ‘inferencing’ stage—comprising collecting the data inside the edge device and building an example to be predicted by the near edge server.

In one embodiment, at least the first phase, and possibly the second phase, is performed offline, while the third phase may be performed online as autonomous devices, each bearing one or more sensors, operate in an operating environment.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of one embodiment is that an embodiment may optimize a lazy feature subset selection for resource-constrained edge devices to enable those resource-constrained edge devices to perform more adaptable predictions in real-time edge environments. An embodiment may reduce the size of an input to a model, which is to be deployed to an edge device, so as to enable the edge device to perform inferencing in real-time, dynamic, environments, and thereby optimize, or at least improve, the performance of the edge device in the environment, based on the inferencing. Various other advantages of one or more example embodiments will be apparent from this disclosure.

### A. Aspects of an Example Context for One Embodiment

The following is a discussion of aspects of an example context for various embodiments. This discussion is not intended to limit the scope of the claims or this disclosure, or the applicability of the embodiments, in any way.

There are some methods for performing feature selection intelligently for machine learning, examples of which are disclosed in U.S. patent application Ser. No. 18/306,578, filed Apr. 25, 2023, entitled “FEATURE SELECTION FOR REAL-TIME INFERENCE WITH MULTIPLE UNRELIABLE SENSORS AT THE EDGE” (“Feature Selection”), which is incorporated herein in its entirety by this reference. In such methods, the goal is to leverage lazy feature selection in the edge. However, none of these methods can deal with resource-constrained edge devices and the optimization of the subset of features selected by each device to improve their accuracy.

Given shortcomings such as these, one or more embodiments are directed to providing smart services for mobile edge devices, for instance, in the logistic space of warehouse management and safety, where there may be multiple mobile edge devices, such as forklifts for example, requiring decisions in real time. In one embodiment, the data collected from various different types of sensors deployed on these mobile device trajectories, that is, the paths traveled by the mobile devices in an environment such as a warehouse, may be leveraged into Machine Learning (ML) models to optimize operation, or to address dangerous circumstances, via object/event detection approaches. In this way, an embodiment may provide smart services to improve the autonomy of these mobile edge devices and add value to customers.

### A.1 Lazy Feature Selection

Lazy feature selection comprises feature selection methods capable of assessing the attribute values of the instances to be classified, using this information to select the subset of features that better discriminate the classes for a particular instance.

It is noted that as used herein, ‘features’ comprise information that can be measured/obtained by, and received from, devices such as sensors. By way of illustration, a data point D that collects data from an accelerometer A, and a GPS sensor G—here, D is formed by the features, that is, the information obtained from the sensors, such as: f0 Acceleration, f1 GPS' latitude, f2 GPS' longitude, and f3 GPS' altitude. In this example case, the data point D has 4 features from the 2 sensors. ‘Consolidating’ the data point D means refers to receipt of the values of the 2 sensors and 4 features at a given instance in time.

To continue now, lazy feature selection is useful in scenarios where the importance of features may vary significantly between the instances. For example, to perform a prediction—such as, for example, which path a forklift should travel—in one corner of a warehouse, features A and B may be the most suitable. However, on the other corner, features C and D may be the most suitable. More than that, the next time the prediction is needed in the same corner, a different set of features may be useful, so it should change constantly. Note that, this kind of adaptation is difficult in traditional model construction and in traditional feature selection where the subset of features selected is fixed. One example of such methods is Lazy Entropy, disclosed in “Pereira, R. B., Plastino, A., Zadrozny, B., de C Merschmann, L. H. and Freitas, A. A., 2011. Lazy attribute selection: Choosing attributes at classification time. Intelligent Data Analysis, 15(5), pp. 715-732” (“Pereira”), which is incorporated herein in its entirety by this reference. In Pereira, the authors provide a feature importance measure to evaluate the importance of a feature value to discriminate the correct class. So, given a data point to be classified, the measure is used to evaluate the subset of features that maximize the entropy between the values and the classes in the training data. These features are then selected to perform the final classification.

A.2 Adapting Classification Algorithms to Perform Predictions with Various Input Sizes

Since the input size varies according to the data point to be classified, we need to employ machine learning models that can change dynamically. Examples of such models are decision trees with lazy construction, such as k-Nearest Neighbors, Bayesian networks and the Naïve Bayes algorithm. For example, given the Naïve Bayes classifier that assigns a class label y=Cₖ for some k as follows:

$$y = arg {max}_{k ϵ \{ 1 , … , K \}} p ( {C}_{k} ) {\prod }_{i = 1}^{n} p ( {x}_{i} \vert {C}_{k} )$$

In a data point, xᵢ represents a feature value. When performing lazy feature selection, an embodiment may adapt this procedure dynamically since an embodiment may skip some values of i in the product of the previous formula, that is, an embodiment may skip the product of feature that are discarded by the feature selection algorithm.

### A.3 Combining Lazy Feature Importance and Health Score to Improve Predictions

The Feature Selection document discloses a method that combines lazy feature importance and health score to improve the prediction on edge devices.

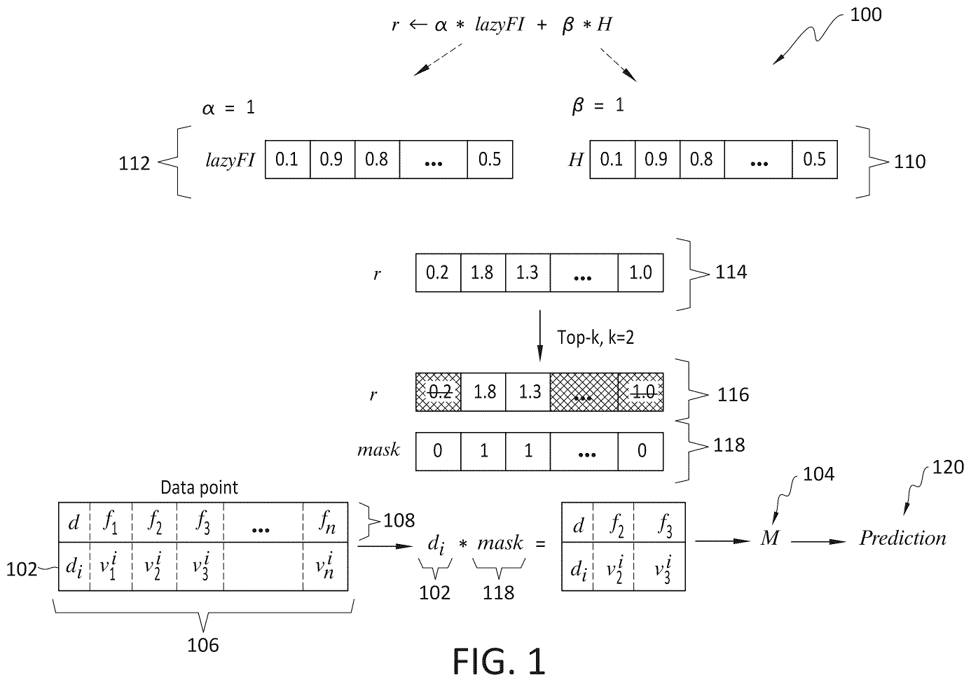

With reference to the example of FIG. 1, an inferencing schema 100 may work as follows: whenever a prediction is necessary, an embodiment may start collecting and aggregating the input, that is, data point dᵢ 102 to a machine learning model M 104. This data point may be formed by, or comprise, sensor data collected during the execution of operations by the edge node and, as such, dᵢ is composed of a set of feature values

$${v}_{1}^{i} , … , {v}_{1}^{n}$$

106, where each feature value comes from a different feature 108 in f₁, . . . , fₙ. The goal is of this step is predicting a class y from dᵢ using the machine learning model M 104, that is, y←M (dᵢ). However, the environment where the edge nodes are deployed may be very unstable, and the feature values can be unreliable.

Then, a lazy feature selection in dᵢ is employed so that the final prediction uses only the features with good feature health values and, further, so that only the feature subset most suitable for performing a good prediction for the given data point. This is done by ranking the features according to their reliability from the feature health score 110 H=H_{E}∪H_{T} and the lazy feature importance given by lazyFI. The lazyFI vector 112 may be calculated using any lazy feature selection measure available in the literature, such as Lazy Entropy, discussed above. Some of these feature importance measures can pre-compute some values for a table to make the computation faster. In this example case, these tables may be pre-computed in the central node, or in a near edge node, and then deployed together with the ML model M 104 to the edge nodes. The following equation defines the feature rank r 114 that is used to select the subset of features used in the classification.

$$r ← α * lazyFI + β * H ,$$

where lazyFI 112 is a vector containing the feature importance of each feature value in the data point, H 110 is a vector containing the feature health scores, α and β are adjustment parameters to weight the final ranking, by default their values are set as 1.

After calculating r 116, an embodiment may select the top k features and use those features as inputs to a prediction method. It is noted that the value of k is a pre-defined parameter set by the expert and should, ideally at least, be a value lower than the total number of features. Alternatively, an embodiment may set a threshold of feature rank score. So, instead of selecting top-k features, an embodiment may simply select all features with scores higher than a threshold. The process of selecting the features generates a mask vector mask 118 that is multiplied by the input data point dᵢ to generate the correct input to the ML model M 104, which may then generate a prediction 120 based on the input.

### B. Overview of Aspects of One Embodiment

### B.1 Introduction

A promising edge space to work on is intelligent services for mobile edge devices, for instance, in the logistics space of warehouse management and factories, where we have multiple mobile devices requiring real-time decisions. The idea is to provide intelligent services to improve the autonomy of these mobile edge devices and add value to customers. The data collected from these mobile devices' trajectories, such as at a customer warehouse for example, and a variety of sensors deployed both in the device and in the environment can be leveraged into Machine Learning (ML) models to optimize operation, or to address dangerous circumstances, via object/event detection approaches.

One or more embodiments may be employed in any environment in which one or more functional edge devices may operate, each such functional edge device comprising one or more sensors or other data gathering devices, and each such functional edge device performing multiple tasks in the environment. While reference is made herein to employment of an embodiment in a logistic warehouse environment, such an environment is provided only for the purposes of illustration, and is not intended to limit the scope of this disclosure, or any claims, in any way.

Each task may depend on a large set of sensors to gather and/or generate data for use as input to an ML model. Note, however, that in harsh environments for example, many sensors might be faulty, malfunctioning, or noisy. The subset of sensor data used to perform a given prediction may vary depending on the condition of the edge position inside the warehouse or factory. So, the usage of these data may be made with parsimony since it could change the output, that is, the predictions or inferences, generated by the models. Moreover, since the edge devices typically have limited computing resources, such as memory, storage, communication bandwidth, and processing, available, the selection of the correct subset of features should be optimized to avoid overconsumption of the resources of the edge device.

One or more embodiments may address a feature selection problem for real-time inference using unreliable sensors in an edge environment. Also, a second problem that arises is the selection of the best subset of features to increase the performance of the model running on resource-constrained devices, that is, the selection of the subset of features should be optimized to increase the performance of the model and at the same time reduce the consumption of resources. Thus, an embodiment may leverage a selection of edge devices and a near-edge node with more computational resources.

### B.2 Discussion

One embodiment comprises a method for feature selection for real-time inference in resource-constrained edge devices. An embodiment of a method may comprise the following elements and operations:

### A. Training/Preparation Stage:

1. Periodically obtain feature health scores at the near edge nodes; this information measures how reliable we could consider a given feature.
2. Obtain a dataset with samples of the data collected for these features.
3. Pre-process the dataset to allow the calculation of feature importance.
4. Build a strong lazy learner by using the collected dataset. By lazy learner, we refer to any classification algorithm that can adapt to a variable number of features at inference time, such as Naïve Bayes, Bayesian Networks, and Decision Trees.

### B. Feature Subset Tuning Stage:

1. Build pre-defined working areas in the environment.
2. Identify the edge devices operating in each area.
3. Randomly assign a different feature subset size for every edge device inside a given area.
4. Receive the feature subset from the edge devices.
5. Aggregate and evaluate the results obtained with each subset size and select the best one.
6. Send the size of the subset of features used inside a given area to edge devices in the area.

### C. Inference:

1. In inference time, consolidate a data point inside the edge device for inference.
2. Given the data point, calculate the (lazy) feature importance for each one of the features in the data point.
3. The feature importance per data point is combined with the feature health score to obtain a final feature score.
4. For the data point, select the top-size subset of features defined by the near-edge node and send them to the near-edge node for inference.
5. Near-edge nodes use the subset to make the prediction and inform the edge node of the result.

### B.3 Further Considerations

As disclosed herein, one or more embodiments may possess various useful features and aspects, although no embodiment is required to possess any of such features or aspects. The following examples are illustrative, but not exhaustive. An embodiment may comprise a method for optimizing the lazy feature subset selection for resource-constrained edge devices to perform more adaptable predictions in real-time edge environments. As another example, an embodiment may comprise a method for reducing the size of an input to a model, so as to enable functional edge devices to perform inferencing in real-time environments.

### C. Detailed Discussion of Aspects of One or More Embodiments

### C.1 Introduction

One or more embodiments address the problem of handling machine learning inference in resource-constrained edge devices on harsh environments. For doing that, an embodiment may comprise a feature selection method capable of reducing the number of features used for inference, keeping only those features that are relevant for a given predictive task. The method may decide, dynamically in response to changing environmental conditions for example, which features to use based on the location of the device inside the environment, feature relevance, and health score of the environment sensors.

It is noted that as used herein, changes to environmental conditions for an edge device may comprise changes in and to the environment itself, and/or changes to the disposition of the edge device within the environment. Examples of the latter include, but are not limited to, a change in the position, speed, bearing, or location, of an edge device in an environment. One embodiment of a feature selection method may comprise three phases, namely:

(1) a first phase comprising a process of collecting training data from a variety of devices—this data is then used for training the lazy classifiers which are stored in a near edge server; (2) a second phase that handles the process of deciding which feature are relevant for each type of location inside the environment—in an embodiment, this process is dynamically run to decide the number of features that should be used in each location of the environment, so that the method may maximize the predictive accuracy and reduce costs with data transmission; and (3) a third phase that comprises collecting the data inside the edge device and building an example to be predicted by the near edge server. These example phases are addressed in further detail below.

### C.2 Training and Data Pre-Processing

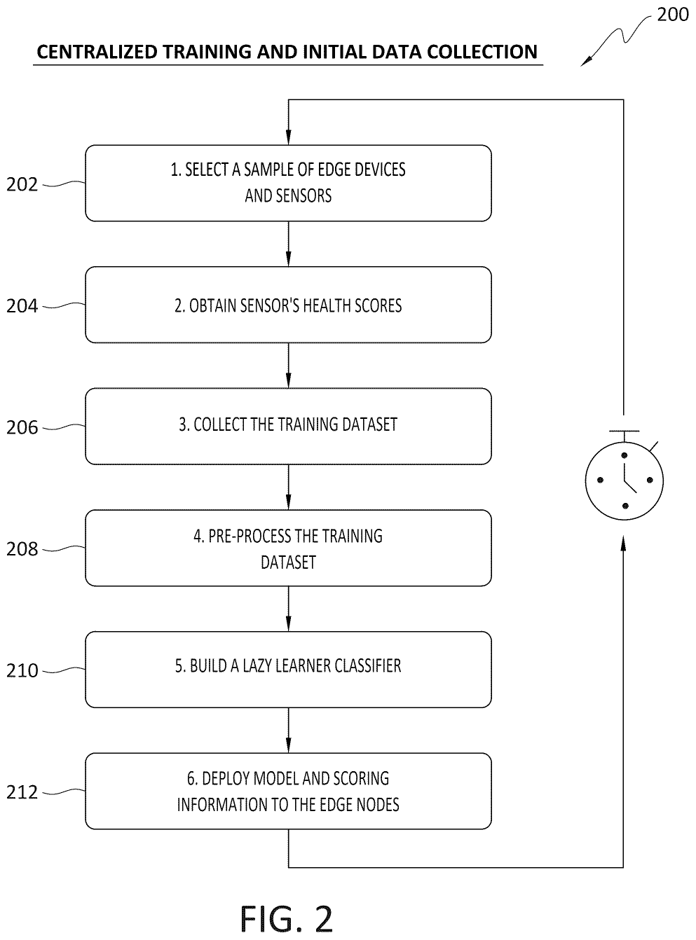

Turning now to FIG. 2, there is disclosed a method for collecting data from edge devices and sensors to build an initial ML model, or simply ‘model.’ Now, given: a collection of edge devices E and a collection of sensors S←{Sₐ+Sₑ}, where S is formed by environment sensors (Sₐ) and edge sensors (Sₑ). In the first phase, the method collects data from all sensors S to train the initial model M. This model M may be a lazy learning algorithm, examples of which include Naïve Bayes, K-NN, and Bayesian Networks. As depicted in FIG. 2, this phase involves collecting data from both edge devices and environment sensors to create the initial model. The process may occur periodically, such as weekly or monthly for example, and/or whenever the developer deems it necessary to keep the central model up-to-date.

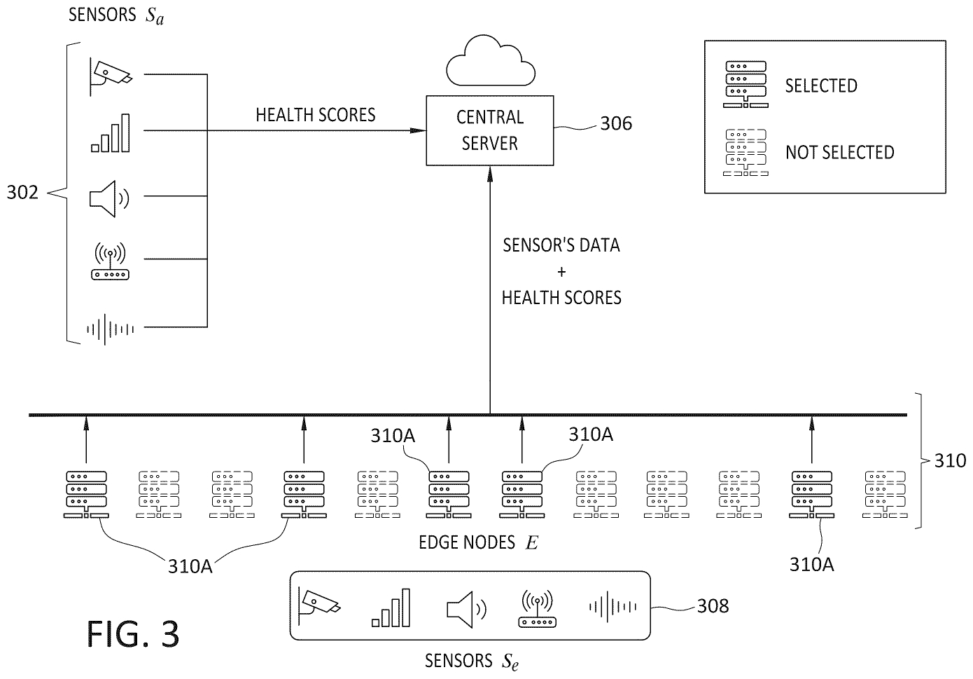

With particular reference now to the example of FIG. 2, an example training and pre-processing method, or phase, 200 may proceed as follows. First, there is a selecting 202 of a sample of the edge devices and sensors to collect the data. There may be a plethora of data to collect a train the central model. However, to save computational time and/or other computational resources, the method 200 may sample the devices to avoid increase computational processing and bandwidth usage. Then, in the second stage, the method 200 obtains 204 respective health scores for the selected sensors. Each sensor may have its own health score that indicates how reliable the sensor is in the data collection process. This score helps in reducing the use of noisy and harsh data. Third, the training data is collected 206 from the sensors in the environment and selected edge devices, as disclosed in the example of FIG. 3.

Particularly, the schema 300 of FIG. 3 comprises a set of environment sensors 302 of various types. Respective health scores 304 for each of the environment sensors 302 in the set are provided to a central server 306 which may, or may not, be hosted at a cloud site, or an on-premises site. As further indicated in FIG. 3, edge sensors 308 of various types and numbers may be deployed at one or more edge nodes 310. As noted herein, one or more of the edge nodes 310 may comprise respective autonomous devices, such as autonomous vehicles, drones, and other systems and devices, any of which may comprise hardware and/or software. In one embodiment, a subset of the edge nodes 310, such as the edge nodes 310A, may be selected to provide edge sensor data and edge sensor health scores to the central server 306.

With continued reference now to the example of FIG. 2, after the data for the training dataset has been collected 206, the training dataset may then be pre-processed 208 for training purposes. Since one embodiment trains a lazy learning algorithm, such an embodiment may need some processing on the training dataset to adapt the data for lazy learning algorithms and models.

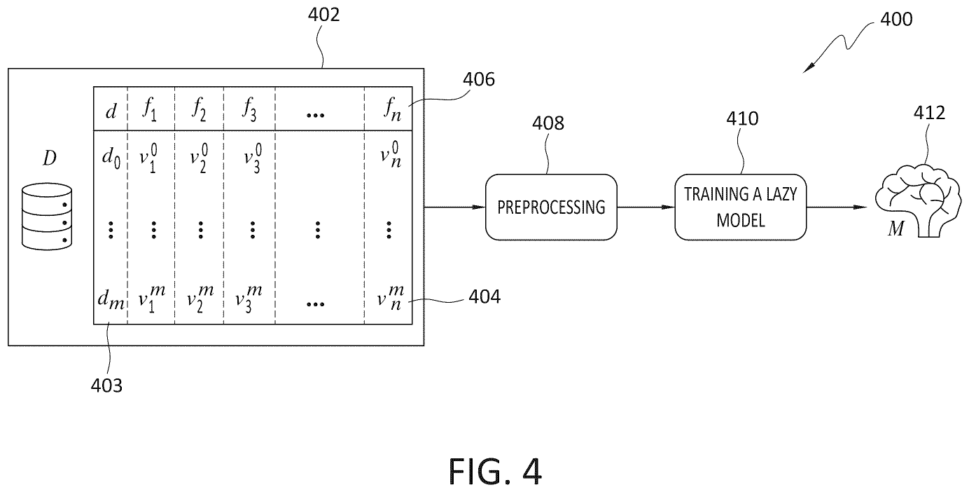

Further, the lazy feature selection applied to the model may be highly dependent on the applied pre-processing techniques. There are a number of techniques that can be used in this part, dependent on the type of target task. An embodiment may apply data normalization to put the continuous data into a given interval range, data discretization to transform numeric into discrete values—this may be necessary for some lazy selection methods, among others. Then an embodiment may build 210 the central model, that is, a lazy learner model, as depicted in FIG. 4. Finally, the final trained lazy learner model may be deployed 212 to all edge devices, so that such model may be used by the edge devices, or near edge device(s), in an inference phase to make predictions.

With reference briefly to the example schema 400 of FIG. 4, a training dataset 402 may comprise various datapoints 403 that each comprise various feature values 404 of one or more features 406. The training dataset 402 may be pre-processed 408, as described above, and the pre-processed data then used to train a lazy learning model 410 or algorithm. This may result in a trained lazy learning model M 412.

### C.3 Feature Subset Tuning

As described earlier, the Feature Selection document discloses a lazy feature selection method to select the best subset of features to make each one of the predictions. This kind of method allows for more specialized selection of features, since we can select a different subset of features depending on the values of the sensors data collected at an inference time. An embodiment may use a fixed threshold k or a threshold value th to discard irrelevant features. However, selecting the most adequate value of k or a threshold of importance value is not an easy task since it should, in one embodiment at least, be previously defined by the user.

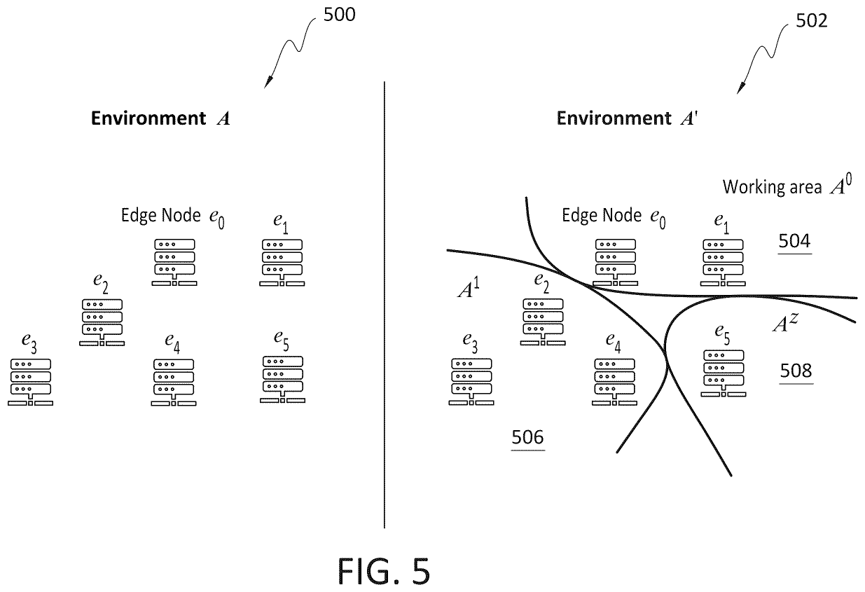

In the following discussion, there is described an efficient method of selecting the best k, or threshold. For this, and with reference now to the example of FIG. 5, an embodiment may divide an environment A 500 of interest into multiple working areas, generally designated as A′ 502, and individually at 504, 506, and 508. Each working area may have its own specialized and optimized value of k. This approach may help in reducing the differences that sensors may have in collecting data on different parts of the environment.

In more detail, an method for dividing an environment, according to one embodiment, may proceed as described hereafter. This is shown in FIG. 5.

Initially, the environment may be divided. In the example of FIG. 5, the environment A 500 is divided into z working areas, three in this example, working areas 504, 506, and 508—there are different methods to divide the environment, for example considering the physical location of the environment, with edge nodes operating inside/outside a warehouse—these working areas can be logical as well, in the example of FIG. 5, the environment is divided according to features of the sensors, type of edge devices, and others.

Second, after z working areas are defined, identify the edge devices operating inside each one of the areas. In the example of FIG. 5, edge nodes e₀ and e₁ are in working area A⁰, edge nodes e₂, e₃, and e₄ are in working area A¹, and edge node e₅ is in working area A².

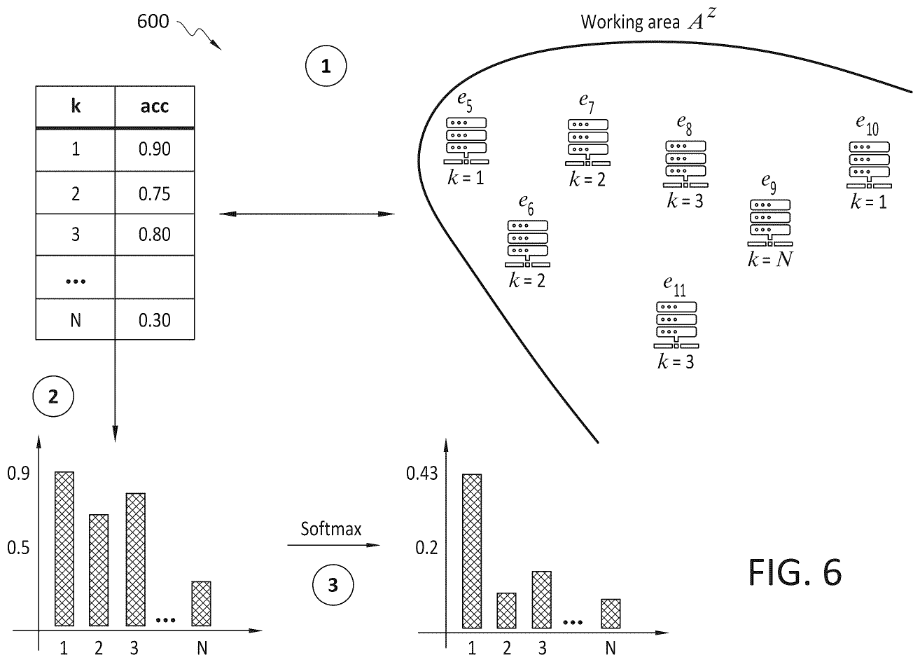

Next, and with reference now with the example of FIG. 6, which discloses a schema 600 for selecting an optimized value of k, an embodiment may operate to (1) send different values of k for edge nodes inside a working area; (2) aggregate the results; and (3) apply a SoftMax to make the values range from 0-1.

In more detail, an embodiment may randomly assign a different value of k (subset size) for each edge device inside a given working area. Each edge device, or near-edge device, may make predictions using the given value of k, aggregate the results, and send the aggregated results back to a central node to enable the central node to build the distributions of k based on the accuracies, and/or any other evaluation metric.

To avoid, or at least reduce, processing performed by the edge node, the edge node device may send the data point to the central node, and/or to a near-edge node, so that those relatively more, that is, relative to the edge node, resourceful nodes perform the inferencing process that produces the prediction. In an embodiment, the central node aggregates the results, builds a distribution of k accuracies, and applies a SoftMax, so that the values can range from 0-1. In this way, an embodiment may be able to sample from the final distribution. The distribution is then sent to the edge devices, or near-edge devices. Then the distribution can be used by the edge nodes or near-edge devices at inference time, enabling diversity in terms of the number of features selected. This process may be repeated from time to time to update the distribution, and make the selection more accurate.

### C.4 Inferencing

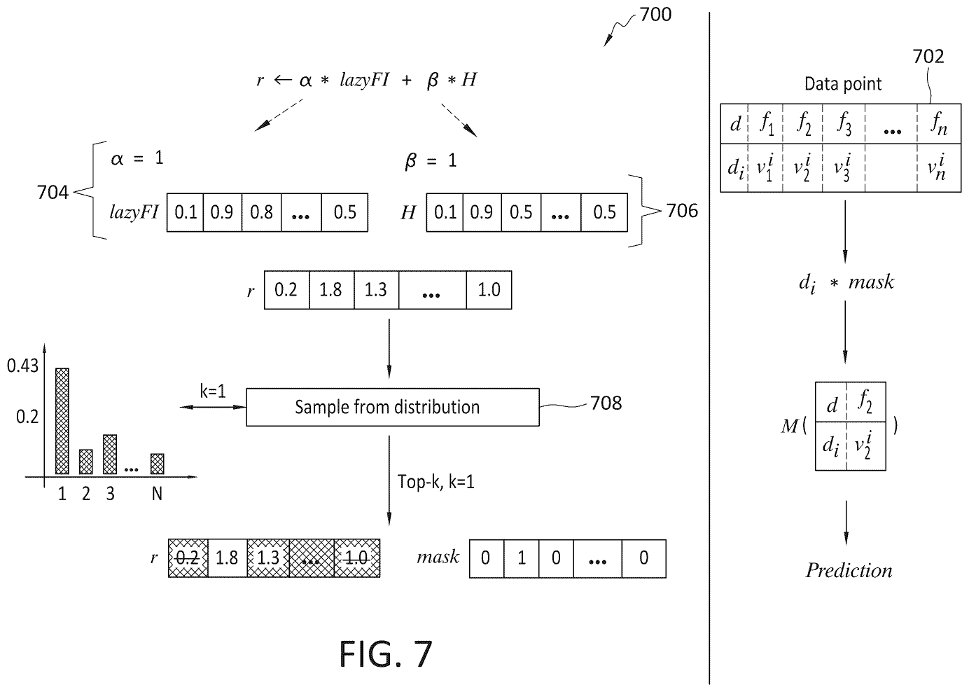

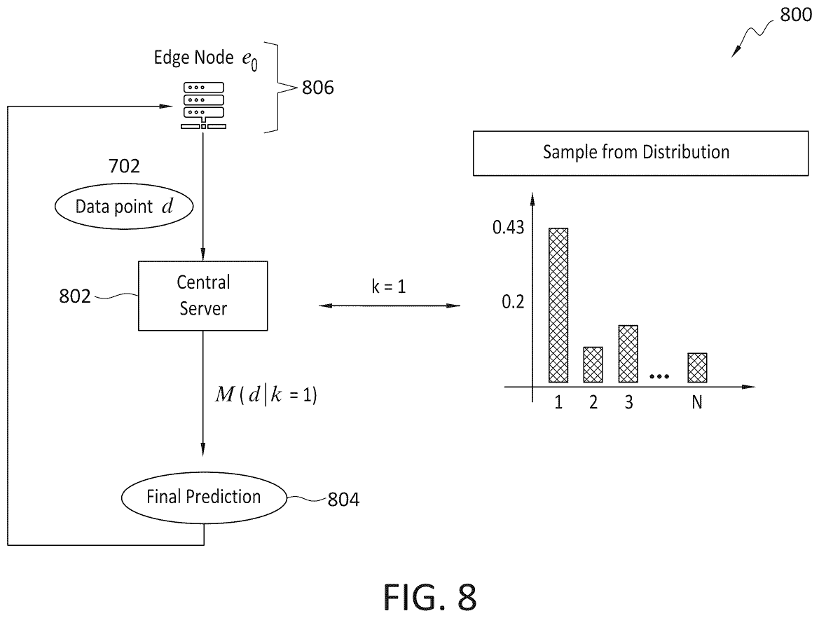

With reference now to the respective schemas 700 and 800 disclosed in FIGS. 7 and 8, once the distribution is calculated, as described above, the distribution may be used by the edge nodes in an inference phase. In one embodiment, the inference process may comprise the following operations:
1. Consolidate, as shown in FIG. 7, a data point 702 inside the edge device 704 for inference. In more detail, a data point is a predictive instance, that is, a set of values sent to the model to enable the model to generate a prediction—in an embodiment, a data point is formed by a collection of measures taken by a sensor, such as feature values for example, where each one of the features values is measured or otherwise obtained by a sensor and corresponds to a particular feature—each sensor may have one, or many, features.
2. Given the data point 702, calculate the lazy feature importance 704 for each one of the features in the data point.
3. The feature importance 704 per data point is combined with the feature health score 706 to obtain a final feature score.
4. For the data point 702, select the top-size subset of features 708 defined by the near-edge node and send them to the near-edge node, or central server 802 as shown in FIG. 8, for inference. Near-edge nodes, or the central server 802, may use the subset to make a final prediction 804 and inform the edge node 806 of the result.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### D. Further Example Embodiments

Following are some further example embodiments. These are presented only by way of example and are not intended to limit the scope of this disclosure or the claims in any way.

Embodiment 1. A method, comprising: receiving, by a near-edge device from each edge device in a work area of an environment, a feature subset, and a size and composition of the feature subset is not fixed; selecting, by the near-edge device, a best feature subset from the feature subsets received from the edge devices; sending, by the near-edge device to the edge devices, a size of the best feature subset; receiving, from one of the edge devices by the near-edge device: a final feature score that is based on a data point that was consolidated at the one edge device; and a top-size subset of features; and using, by the near-edge device, the top-size subset of features to generate a prediction, and transmitting the prediction to the edge device.

Embodiment 2. The method as recited in any preceding embodiment, wherein features included in the feature subset each pertain to a respective sensor associated with the edge device.

Embodiment 3. The method as recited in any preceding embodiment, wherein the prediction is usable by the edge device to autonomously control operation of the edge device in an environment.

Embodiment 4. The method as recited in any preceding embodiment, wherein, for one of the edge devices, the feature subsets of the one edge device is smaller in size than a set of all features associated with the one edge device.

Embodiment 5. The method as recited in any preceding embodiment, wherein the near-edge device uses a lazy learning model to make the prediction.

Embodiment 6. The method as recited in any preceding embodiment, wherein, for one of the edge devices, the feature subset for the one edge device includes only those features determined by the one edge device to be most relevant to the one edge device.

Embodiment 7. The method as recited in any preceding embodiment, wherein the final feature score comprises a sum of a feature importance for the data point and a feature health score.

Embodiment 8. The method as recited in any preceding embodiment, wherein the edge devices comprise environment sensors and/or edge sensors.

Embodiment 9. The method as recited in any preceding embodiment, wherein the prediction is an output of an inferencing process performed by the near-edge device based on the data point that was consolidated in the edge device.

Embodiment 10. The method as recited in any preceding embodiment, wherein the prediction is made in real time while one of the edge devices is operating in the work area.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These May be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

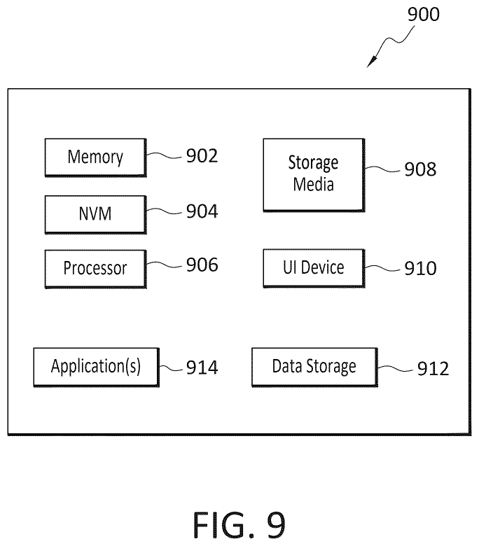

With reference briefly now to FIG. 9, any one or more of the entities disclosed, or implied, by FIGS. 1-8, and/or elsewhere herein, may take the form of, or include, or be implemented on, or hosted by, a physical computing device, one example of which is denoted at 900. As well, where any of the aforementioned elements comprise or consist of a virtual machine (VM), that VM may constitute a virtualization of any combination of the physical components disclosed in FIG. 9.

In the example of FIG. 9, the physical computing device 900 includes a memory 902 which may include one, some, or all, of random access memory (RAM), non-volatile memory (NVM) 904 such as NVRAM for example, read-only memory (ROM), and persistent memory, one or more hardware processors 906, non-transitory storage media 908, Ul device 910, and data storage 912. One or more of the memory components 902 of the physical computing device 900 may take the form of solid state device (SSD) storage. As well, one or more applications 914 may be provided that comprise instructions executable by one or more hardware processors 906 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
receiving, by a near-edge device from each edge device in a work area of an environment, a feature subset, and a size and composition of the feature subset is not fixed;
selecting, by the near-edge device, a best feature subset from the feature subsets received from the edge devices;
sending, by the near-edge device to the edge devices, a size of the best feature subset;
receiving, from one of the edge devices by the near-edge device:
a final feature score that is based on a data point that was consolidated at the one edge device; and
a top-size subset of features; and
using, by the near-edge device, the top-size subset of features to generate a prediction, and transmitting the prediction to the edge device.

2. The method as recited in claim 1, wherein features included in the feature subset each pertain to a respective sensor associated with the edge device.

3. The method as recited in claim 1, wherein the prediction is usable by the edge device to autonomously control operation of the edge device in an environment.

4. The method as recited in claim 1, wherein, for one of the edge devices, the feature subsets of the one edge device is smaller in size than a set of all features associated with the one edge device.

5. The method as recited in claim 1, wherein the near-edge device uses a lazy learning model to make the prediction.

6. The method as recited in claim 1, wherein, for one of the edge devices, the feature subset for the one edge device includes only those features determined by the one edge device to be most relevant to the one edge device.

7. The method as recited in claim 1, wherein the final feature score comprises a sum of a feature importance for the data point and a feature health score.

8. The method as recited in claim 1, wherein the edge devices comprise environment sensors and/or edge sensors.

9. The method as recited in claim 1, wherein the prediction is an output of an inferencing process performed by the near-edge device based on the data point that was consolidated in the edge device.

10. The method as recited in claim 1, wherein the prediction is made in real time while one of the edge devices is operating in the work area.

11. A non-transitory storage medium having stored therein instructions that are executable by one or more hardware processors to perform operations comprising:
receiving, by a near-edge device from each edge device in a work area of an environment, a feature subset, and a size and composition of the feature subset is not fixed;
selecting, by the near-edge device, a best feature subset from the feature subsets received from the edge devices;
sending, by the near-edge device to the edge devices, a size of the best feature subset;
receiving, from one of the edge devices by the near-edge device:
a final feature score that is based on a data point that was consolidated at the one edge device; and
a top-size subset of features; and
using, by the near-edge device, the top-size subset of features to generate a prediction, and transmitting the prediction to the edge device.

12. The non-transitory storage medium as recited in claim 11, wherein features included in the feature subset each pertain to a respective sensor associated with the edge device.

13. The non-transitory storage medium as recited in claim 11, wherein the prediction is usable by the edge device to autonomously control operation of the edge device in an environment.

14. The non-transitory storage medium as recited in claim 11, wherein, for one of the edge devices, the feature subsets of the one edge device is smaller in size than a set of all features associated with the one edge device.

15. The non-transitory storage medium as recited in claim 11, wherein the near-edge device uses a lazy learning model to make the prediction.

16. The non-transitory storage medium as recited in claim 11, wherein, for one of the edge devices, the feature subset for the one edge device includes only those features determined by the one edge device to be most relevant to the one edge device.

17. The non-transitory storage medium as recited in claim 11, wherein the final feature score comprises a sum of a feature importance for the data point and a feature health score.

18. The non-transitory storage medium as recited in claim 11, wherein the edge devices comprise environment sensors and/or edge sensors.

19. The non-transitory storage medium as recited in claim 11, wherein the prediction is an output of an inferencing process performed by the near-edge device based on the data point that was consolidated in the edge device.

20. The non-transitory storage medium as recited in claim 11, wherein the prediction is made in real time while one of the edge devices is operating in the work area.
